(19) United States
(12) Patent Application Publication
(10) Pub. No.: US 2007/0029315 A1
(43) Pub. Date: Feb. 8, 2007

(54) Microwave heating unit

(76) Inventors: Minoru Ishida, Mobara-shi (JP); Toshio Ogura, Mobara-shi (JP); Susumu Kowase, Isesaki-shi (JP); Junichiro Kasuya, Isesaki-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 11/488,131

(22) Filed: Jul. 18, 2006

(30) Foreign Application Priority Data
Jul. 20, 2005 (JP) 2005-209672

(51) Int. Cl. H05B 6/80

(52) U.S. Cl. 219/730

(57) ABSTRACT

A microwave heating unit has a construction to supply a microwave generated by a magnetron to a microwave irradiation chamber having a cylinder in which a container is stored and to irradiate the microwave supplied to the microwave irradiation chamber to a part of a container so that a convection flow is generated in a liquid in the container. By this construction, without requiring a complicated construction for uniform irradiation on the whole surface of the container, uniform heating on the entire liquid stored in the container is made possible with a simplified construction for irradiation of a microwave.

### BACKGROUND OF THE INVENTION

(i) Field of the Invention

The present invention relates to a microwave heating unit for heating a liquid such as drink contained in a container such as a polyethylene terephthalate bottle or the like which transmits a microwave easily, which is a microwave heating unit incorporated in an automatic vending machine and the like, for example.

(ii) Description of the Related Art

A conventional microwave heating unit supplies a microwave generated by magnetron to a microwave irradiation chamber through a wave guide for 2.45 GHz for efficient supply. The microwave irradiation chamber to which the microwave is supplied is larger in size than an object to be irradiated and heated by the microwave and stores the entire object to be irradiated therein for heating. Such a microwave heating unit is widely known as a so-called microwave oven.

Some of the microwave supplied to the microwave irradiation chamber through the wave guide is directly absorbed by the object to be irradiated but others are not. The microwave which is not directly absorbed by the object to be irradiated is reflected by a wall surface of the microwave irradiation chamber and then, absorbed by the object to be irradiated again. As a result, the microwave is absorbed by substantially the whole surface of the object to be irradiated and the object to be irradiated is heated to the inside.

As a conventional art to make the microwave absorbed by the whole surface of the object to be irradiated, provision of an electric wave agitating blade for agitating the microwave in the microwave irradiation chamber or a turntable for rotating the object to be irradiated is generally practiced.

By irradiating the microwave to the whole surface of the object to be irradiated using the electric wave agitating blade or turn table, uniform heating of the object to be irradiated is improved. This type of microwave heating unit using the electric wave agitating blade or the turn table is effective for uniformly heating particularly when the object to be irradiated is substantially planar and has a relatively large surface area, or for heating those with low heat conductance in view of the nature of the object to be irradiated.

When those with high heat conductance and relatively large volume such as a liquid contained in a container, an alcoholic beverage in a glass or a soft drink in a PET bottle sold in the market, for example, is to be irradiated, uniform irradiation of the microwave is possible for uniform heating from the whole surface of the container with the same construction as above. However, the microwave heating unit for uniformly heating such liquid in a container is provided with a microwave feed port in the microwave irradiation chamber for irradiating the microwave generated by a plurality of magnetrons to respective objects to be irradiated or a plurality of microwave feed ports for irradiating the microwave generated by a single magnetron to the object to be irradiated through the plurality of microwave feed ports.

Also, as a construction to improve uneven heating by uniform irradiation of the microwave, another high-frequency heating unit is so constituted that an opening area of each of the plurality of microwave feed ports is different from each other so as to control power of the microwave for irradiation.

Thus, the constructions of these heating units are complicated.

### SUMMARY OF THE INVENTION

An object of the present invention is to provide a microwave heating unit which can uniformly heat a liquid contained in a container with a simplified construction for irradiating a microwave.

In order to achieve the above object, the present invention is a microwave heating unit for heating a liquid contained in a container by a microwave, provided with a magnetron for generating the microwave, a microwave irradiation chamber having a cylinder in which the container is stored, and a wave guide for supplying the microwave generated by the magnetron to the microwave irradiation chamber and irradiates the microwave supplied to the microwave irradiation chamber to a part of the container so that a convection flow is generated in the liquid in the container.

According to this microwave heating unit, since the microwave supplied to the microwave irradiation chamber is irradiated to a part of the container so that the convection flow is generated in the liquid in the container, the convection flow is generated with efficiency in the liquid in the container, which enables uniform heating. By this, without requiring a complicated construction for uniform irradiation on the whole surface of the container, the entire liquid contained in the container can be uniformly heated with the simplified construction for irradiating a microwave.

The above object as well as other objects, characteristics and benefits of the present invention will be made clear from the description below and the attached drawings.

### BRIEF DESCRIPTION OF THE DRAWINGS

FIG. 1 is a front view for explaining a construction of an automatic vending machine in which a microwave heating unit is incorporated;

FIG. 2 is a view for explaining the microwave heating unit provided inside the automatic vending machine shown in FIG. 1;

FIG. 3 is a top view of a microwave irradiation chamber;

FIG. 4 is a side view of a magnetron;

FIG. 5 is a side view of a PET bottle type drink;

FIG. 6 is a side view of the microwave irradiation chamber;

FIG. 7 is aside sectional view of the microwave irradiation chamber;

FIG. 8 is a view for explaining a state where the drink is to be stored in the microwave heating unit;

FIG. 9 is a sectional view for explaining a state where the drink is stored in the microwave heating unit;

FIG. 10 is a view for explaining measurement spots of a temperature of the container surface of the drink heated in the state in FIG. 9;

FIG. 11 is a view for explaining a state where the drink is to be stored in the microwave heating unit;

FIG. 12 is a sectional view for explaining a state where the drink is stored in the microwave heating unit;

FIG. 13 is a view for explaining a state where the drink is to be stored in the microwave heating unit;

FIG. 14 is a sectional view for explaining a state where the drink is stored in the microwave heating unit;

FIG. 15 is a view for explaining a measurement spot of a temperature of the container surface of the drink heated in the state in FIG. 14;

FIG. 16 is a sectional view for explaining a state where the drink is stored in the microwave heating unit; and

FIG. 17 is a view for explaining temperature measurement of the drink by an infrared thermometer.

### DESCRIPTION OF THE PREFERRED EMBODIMENTS

A liquid such as a beverage contained in a container will be described as an object to be heated herein. That is, the object to be heated is the liquid contained in the container. However, heating of the liquid involves heating of the container, and in the state where the liquid is heated to a predetermined temperature, the container itself is considered to have been heated similarly.

### FIRST PREFERRED EMBODIMENT

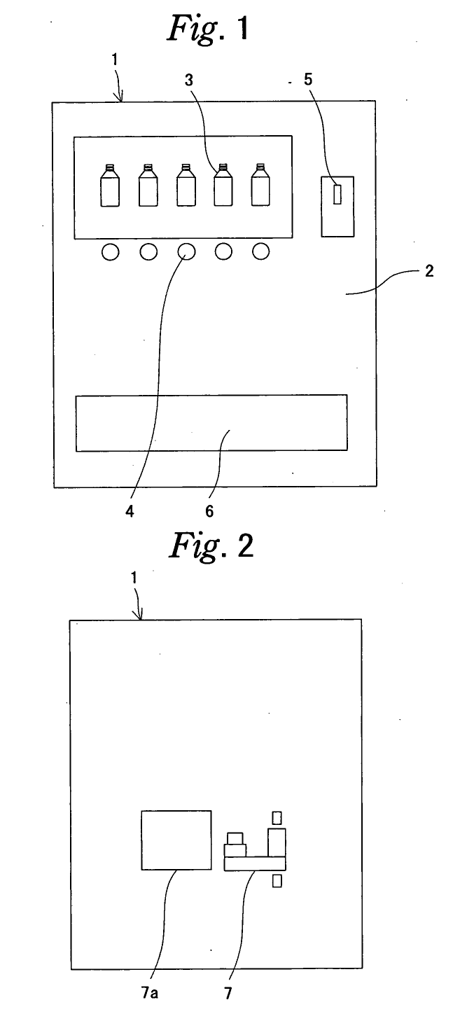

FIGS. 1 to 12 show a first preferred embodiment of the present invention, in which FIG. 1 is a front view for explaining a construction of an automatic vending machine incorporating a microwave heating unit of the present invention. In FIG. 1, on a front surface of an automatic vending machine body 1, a front door 2 is provided, and at an upper part of the front door 2, samples 3 showing a plurality of beverages sold by the automatic vending machine and the state where they are contained in containers such as glass bottles, PET bottles and the like, a plurality of drink selection buttons 4 corresponding to the respective samples 3, and a coin slot 5 for purchasing the drink are provided. Also, at a lower part of the front door 2, a gate 6 to take out the drink is provided. The drink in the container will be simply referred to as a drink hereafter.

FIG. 2 is a view for explaining the microwave heating unit provided inside the automatic vending machine shown in FIG. 1. The microwave heating unit 7 of this preferred embodiment is provided inside the front door 2 of the automatic vending machine body 1 shown in FIG. 1 and driven by a power source 7a. In the automatic vending machine, when a purchaser of a drink throws in a coin or the like through the coin slot 5 and presses the drink selection button 4, the same drink as the sample 3, which is an object to be irradiated by the microwave, is fed to the microwave heating unit 7 and heated by the microwave to a required temperature.

After heating of the drink is completed, the drink is fed from the microwave heating unit 7 to the drink takeout gate 6 shown in FIG. 1. By this, the purchaser can obtain the same drink as the sample 3 heated to the required temperature.

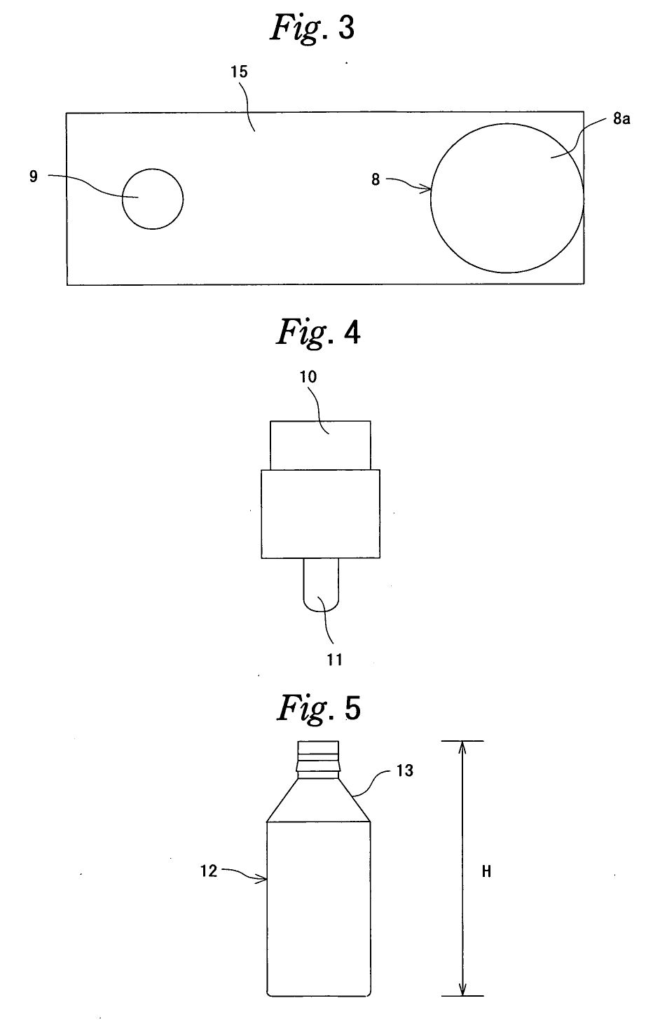

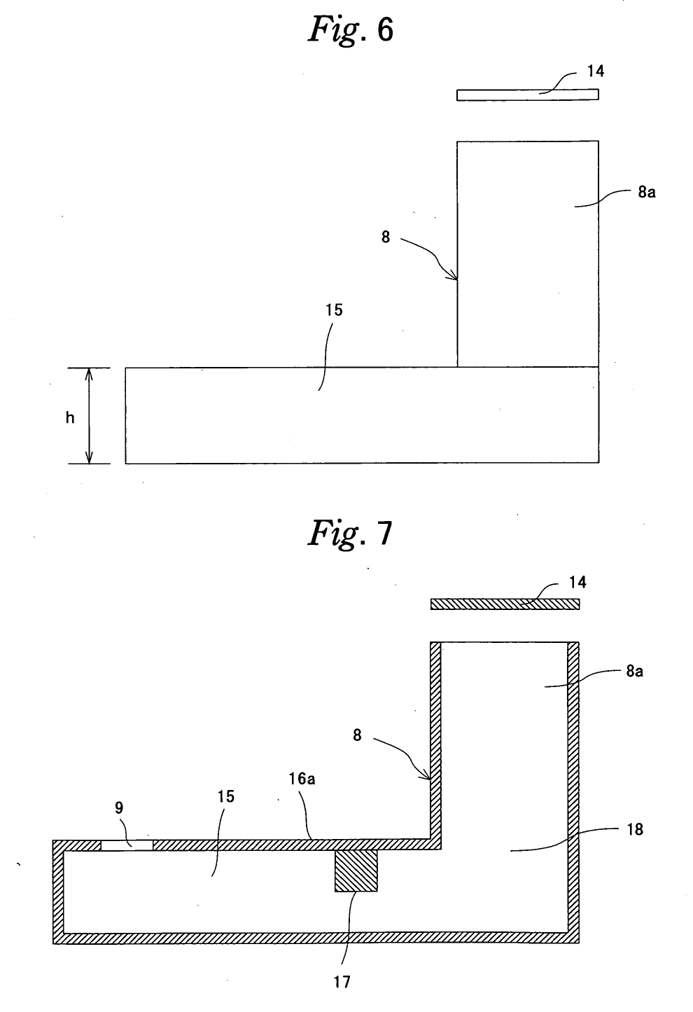

Next, a microwave irradiation chamber of the microwave heating unit 7 of this preferred embodiment will be described using FIGS. 3 to 7. FIG. 3 is a top view of the microwave irradiation chamber, FIG. 4 is a side view of a magnetron, FIG. 5 is a side view of the PET bottle type drink, FIG. 6 is a side view of the microwave irradiation chamber, and FIG. 7 is a side sectional view of the microwave irradiation chamber. A PET bottle type drink will be used as a drink in the following description.

In FIGS. 3 to 7, the microwave irradiation chamber 8 has a cylinder 8a (to be an actual microwave irradiation chamber) for storing a PET bottle type drink 12 as an object to be irradiated shown in FIG. 5, and an antenna 11 of a magnetron 10 for generating a microwave shown in FIG. 4 is inserted into a hole 9 provided at a wave guide 15. In FIG. 6, a lid 14 closes an opening of the cylinder 8a to prevent leakage of the microwave in the cylinder 8a, and the wave guide 15 propagates and supplies the microwave emitted by the antenna 11 of the magnetron 10 to the microwave irradiation chamber 8, that is, the cylinder 8a.

In FIG. 7, on the inside of a horizontal upper face 16a of the wave guide 15, a stub tuner 17 functioning as a matching stub is provided for having the microwave emitted by the antenna 11 of the magnetron 10 to enter the PET bottle type drink 12 with efficiency. In this preferred embodiment, an opening portion 18 is provided to open a part of the horizontal upper face 16a of the wave guide 15 to be connected to the cylinder 8. The PET bottle type drink 12 is stored in the opening portion 18. Heights of the PET bottle type drinks 12 are varied, but with regard to the PET bottle type drink 12 of the smallest size among those handled herein, it is preferable that a height h of the wave guide 15 for a height H of the PET bottle type drink 12 is 0.1×H≦h≦0.8×H, for example. By this, the microwave is irradiated to a part of the container of the PET bottle type drink 12. In this preferred embodiment, the cylinder 8a in which the PET bottle type drink 12 is stored is cylindrical, but that may be an oval, polygon or the like other than a cylinder.

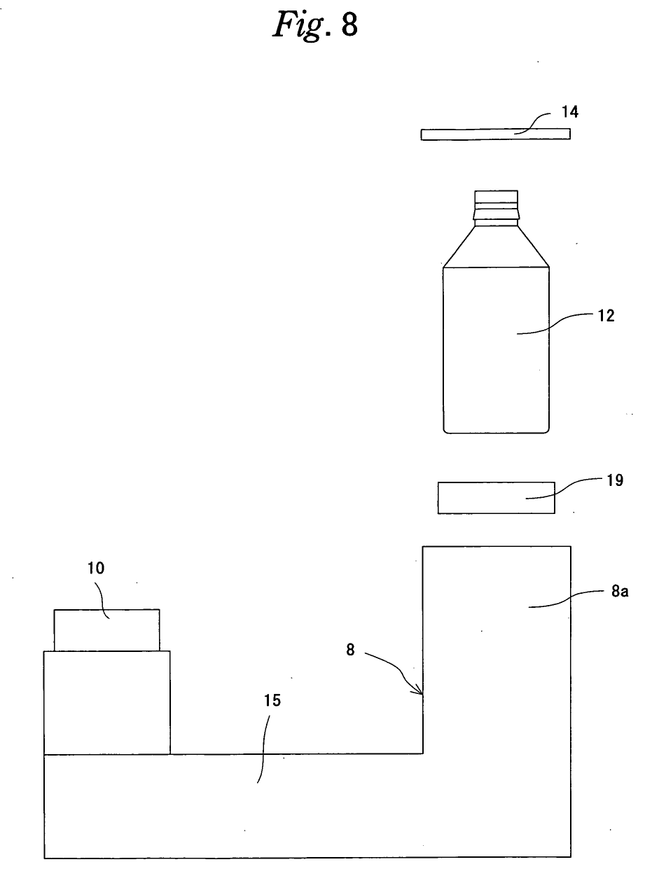

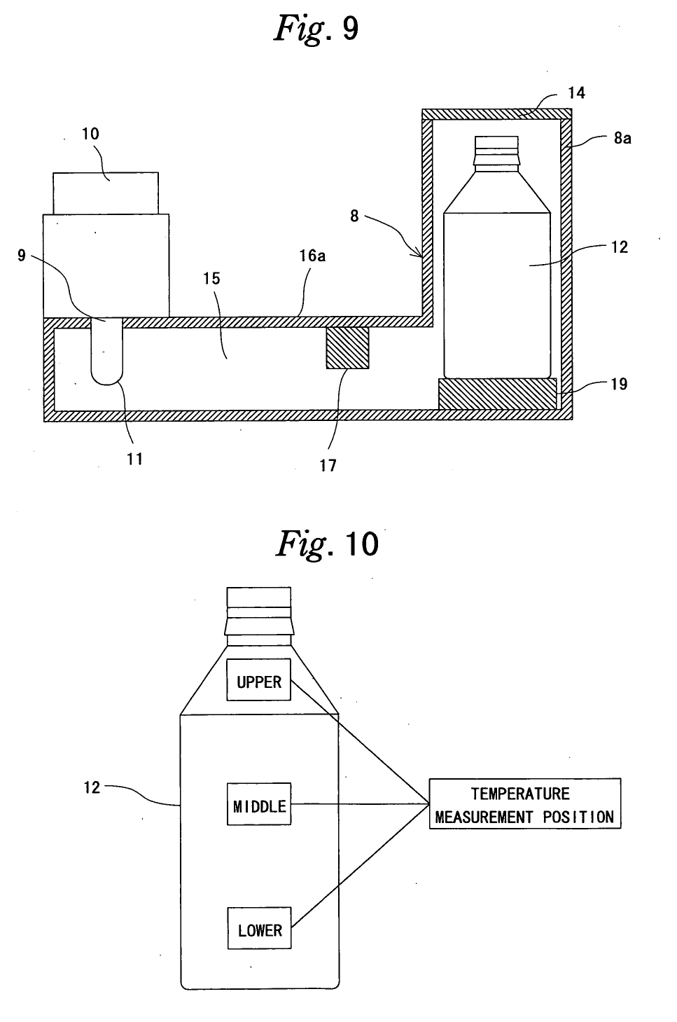

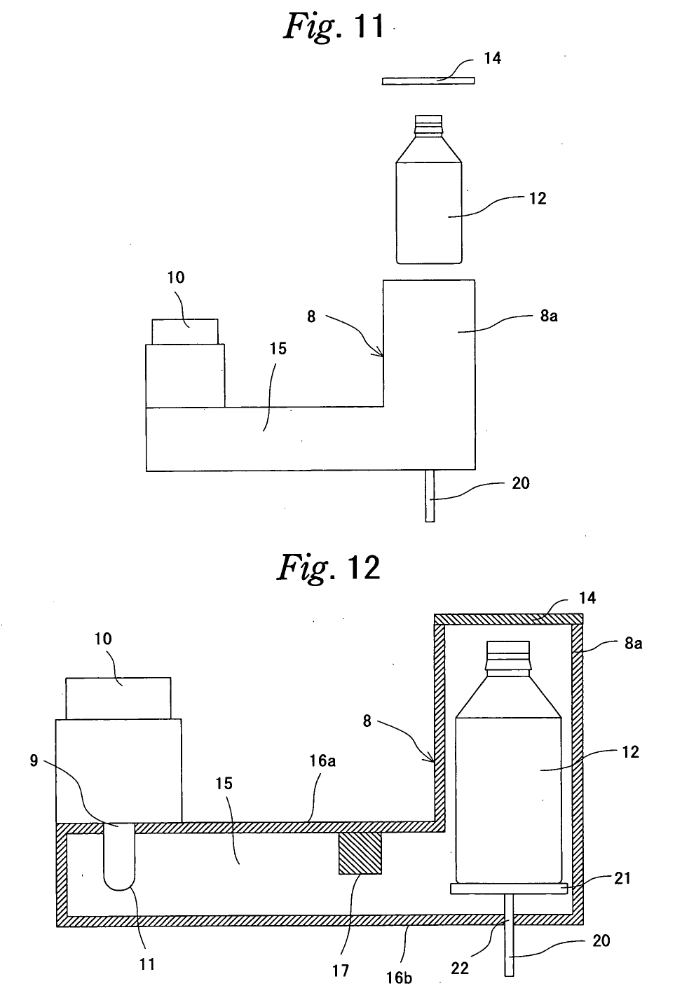

Next, a method for uniformly heating the entire container of the PET bottle type drink 12 will be described using FIGS. 8 to 12. FIG. 8 is a view for explaining a state where the drink is to be stored in the microwave heating unit, FIG. 9 is a sectional view for explaining a state where the drink has been stored in the microwave heating unit, FIG. 10 is a view for explaining measurement spots of a temperature of the container surface of the drink heated in the state in FIG. 9, FIG. 11 is a view for explaining a state where the drink is to be stored in the microwave heating unit, and FIG. 12 is a sectional view for explaining a state where the drink has been stored in the microwave heating unit.

FIG. 8 shows a state after the antenna 11 is inserted into the hole 9 and the magnetron 10 is attached to the wave guide 15, and before the PET bottle type drink 12 and a base 19 for changing a position of the wave guide 15 in the height direction with respect to the stored PET bottle type drink 12 are stored in the cylinder 8a and the lid 14 is closed. FIG. 9 shows a state where the PET bottle type drink 12 and the base 19 have been stored in the cylinder 8a and the lid 14 has been closed. In FIG. 9, a material of the base 19 is preferably Teflon or the like with small microwave absorbance. By this, the microwave is also irradiated to the bottom surface of the container of the PET bottle type drink 12.

In FIG. 9, the height of the base 19 was changed to three cases: a case where 280 mL (milliliter) of tap water is filled in a PET bottle as the PET bottle type drink 12 without the base, a case with the base with a height of 8 mm, and a case with the base with a height of 15 mm, and after an initial temperature of 5 degrees of the tap water in the PET bottle is heated to such as 55 degrees of the heating completed temperature, and the temperature was measured at each measurement position shown in FIG. 10. The results are shown in Table 1.

[Table 1]

TABLE 1

| | PET bottle temperature (normalized by upper temperature) | | | |
|---|---|---|---|---|
| Base | Upper | Middle | Lower | Difference |
| height | temperature | temperature | temperature | (max. − min.) |
| None | 1.00 | 1.01 | 0.61 | 0.4 |
| 8 mm | 1.00 | 0.96 | 0.75 | 0.25 |
| 15 mm | 1.00 | 0.97 | 0.92 | 0.08 |

The temperature measurement results in Table 1 are taken at three temperature measurement spots of an upper part, a center part and a lower part of a container (PET bottle) as shown in FIG. 10, and the values are normalized based on the temperature at the upper part. It was found out from the results that the temperatures at the upper part, center part and lower part of the container (PET bottle) become substantially uniform with increase of the height of the base 19.

It was confirmed from the experiment that the optimal value for the height of the base 19 to make the temperature of the entire container uniform is varied depending on the shape and capacity of the container (PET bottle). Thus, a construction with the purpose of freely changing the height of the base 19, that is, a position of the wave guide in the height direction in the container is shown in FIGS. 11 and 12. In FIG. 12, a loading table 21 on which the PET bottle type drink 12 stored in the cylinder 8a is loaded and an adjustment rod 20 for moving the loading table 21 in a height direction of the wave guide 15 are connected to each other, and an insertion hole 22 through which the adjustment rod 20 can go in and out is opened at a part of a horizontal lower face 16b of the wave guide 15. It is preferably that Teflon or the like with small microwave absorbance is used for a material of the adjustment rod 20 and the loading table 21. The position of the insertion hole 22 is preferable on the center axis of the opening portion 18 shown in FIG. 7, and leakage of the microwave can be prevented by setting the size of the insertion hole 22 to φ 10 mm or less. In this preferred embodiment, a method for changing the height from the lower part of the PET bottle, which is a container, by the adjustment rod 21 was described, but it may be a method to suspend the PET bottle from above.

According to the microwave heating unit in this preferred embodiment in this way, since the microwave is irradiated to a part of the container by changing the position of the wave guide 15 in the height direction in the container (PET bottle), which is an object to be irradiated, stored in the cylinder 8a, a convection flow can be generated efficiently in the drink in the container and the drink can be heated uniformly. Therefore, the liquid contained in the container can be heated uniformly by a simplified construction for irradiation of the microwave without requiring a complicated construction for uniform irradiation on the whole surface of the container.

### SECOND PREFERRED EMBODIMENT

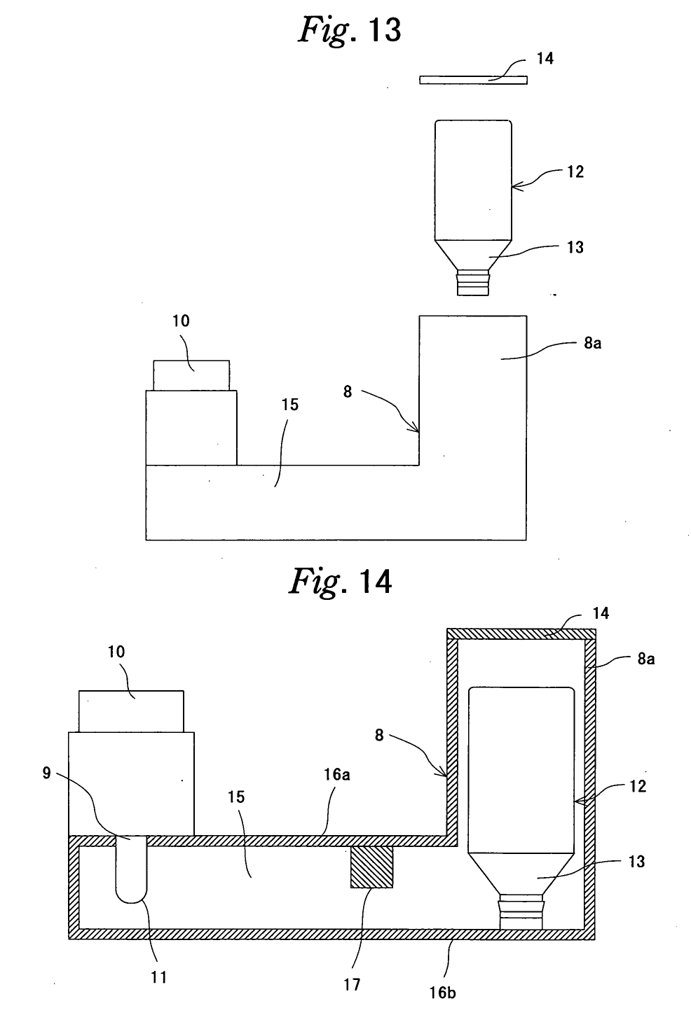

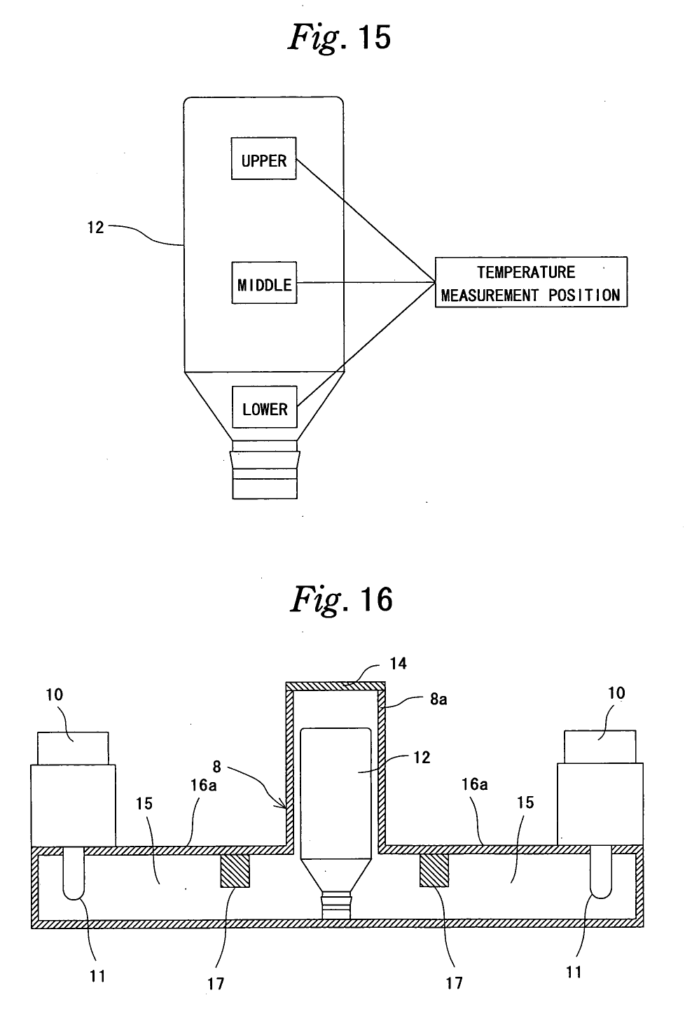

FIGS. 13 to 15 show a second preferred embodiment of the present invention, in which FIG. 13 is a view for explaining a state where the drink is to be stored in the microwave heating unit, FIG. 14 is a sectional view for explaining a state where the drink has been stored in the microwave heating unit, and FIG. 15 is a view for explaining spots for measuring the temperature on the container surface of the drink heated in the state of FIG. 14. In the second preferred embodiment, the container (PET bottle) of the PET bottle type drink 12 is stored in the cylinder 8a with its spout 13 faced toward a horizontal lower face 16b side of the wave guide 15, that is, the PET bottle type drink 12 is inserted in the inverted state. At this time, the PET bottle type drink 12 preferably has the spout 13 in the hourglass shape as the shape of a bottle. By this, the microwave can be irradiated to the vicinity of the hourglass-shaped spout 13 of the container of the PET bottle type drink 12.

Two types of containers (PET bottle) of 280 mL and 350 mL are filled with tap water as the PET bottle type drink 12 in FIG. 14, and after the initial temperature of 5 degrees of the tap water in the container (PET bottle) is heated to such as 55 degrees of the heating completed temperature, temperatures are measured at measurement spots shown in FIG. 15, whose results are indicated in Table 2.

[Table 2]

TABLE 2

| | PET bottle temperature (normalized by upper temperature) | | | |
|---|---|---|---|---|
| PET bottle | Upper | Middle | Lower | Difference |
| capacity | temperature | temperature | temperature | (max. − min.) |
| 280 mL | 1.00 | 0.99 | 0.98 | 0.02 |
| 350 mL | 1.00 | 099 | 0.97 | 0.03 |

The temperature measurement results in Table 2 are taken at three temperature measurement spots of an upper part, a center part and a lower part of a container (PET bottle) as shown in FIG. 15, and the values are normalized based on the temperature at an upper part. It was found out from the results that the temperatures at the upper part, center part and lower part of the container (PET bottle) are substantially uniform irrespective of the difference in capacity of 280 mL and 350 mL.

According to the microwave heating unit in this preferred embodiment in this way, since the microwave is irradiated to the vicinity of the spout 13 by storing the container in the bottle shape in the cylinder 8a with the spout 13 faced toward the horizontal lower face 16b side of the wave guide 15, a convection flow can be generated efficiently in the drink in the container and the drink can be heated uniformly. Therefore, the liquid contained in the container can be heated uniformly by a simplified construction for irradiation of the microwave without requiring a complicated construction for uniform irradiation on the whole surface of the container.

### THIRD PREFERRED EMBODIMENT

FIG. 16 shows a third preferred embodiment of the present invention, showing a sectional view of a magnetron heating device. In the third preferred embodiment, two magnetrons 10 described in FIG. 14 are mounted to the wave guide 15.

By employing a construction that the microwave is irradiated from two directions to the PET bottle type drink 12 in this way, heating can be accomplished in a shorter time. Note that the number of the magnetrons 10 may be increased and the wave guide 15 may be arranged in a star shape so that heating can be done with higher energy.

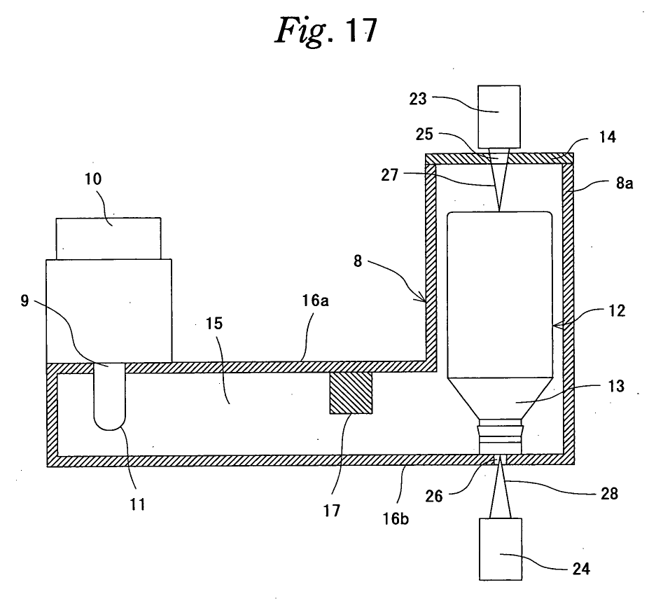

FIG. 17 is a view for explaining temperature measurement of the drink by an infrared thermometer. As shown in FIG. 17, the temperature of the PET bottle type drink 12 is measured by providing infrared radiation thermometers 23, 24 on a bottom face side of the container (PET bottle) of the PET bottle type drink 12 and/or an upper face side (spout side) of the PET bottle type drink 12. On the lid 14 of the cylinder 8a and/or the horizontal lower face 16b of the wave guide 15, measurement holes 25, 26 through which infrared rays 27, 28 passes at temperature measurement by the infrared radiation thermometers 23, 24 are opened.

The opening position of the measurement hole 25 is preferably on the center axis of the cylinder 8a on which the lid 14 is installed, and leakage of the microwave can be prevented by setting the size of the measurement hole 25 to approximately φ 10 mm or less. The opening position of the measurement hole 26 is preferably on the center axis of the opening portion 18 shown in FIG. 7, and leakage of the microwave can be prevented by setting the size of the measurement hole 26 to approximately φ 10 mm or less. Note that an infrared radiation thermometer is used as a temperature measuring instrument in this preferred embodiment, but it may be a measurement construction that a thermocouple thermometer is brought into a direct contact with the container of the PET bottle type drink 12. By this, it becomes possible to measure the temperature of an uniformly heated object by an infrared radiation thermometer or a thermocouple thermometer or the like irrespective of the measurement position of the object to be irradiated, and heating can be controlled by incorporating a mechanism which can stop irradiation of the microwave when the object to be irradiated is heated to a required temperature.

What is claimed is:

1. A microwave heating unit for heating a liquid contained in a container by a microwave, comprising:
a magnetron for generating a microwave;
a microwave irradiation chamber having a cylinder in which the container is stored; and
a wave guide for supplying the microwave generated by the magnetron to the microwave irradiation chamber, wherein
the microwave supplied to the microwave irradiation chamber is irradiated to a part of the container so that a convection flow is generated in the liquid in the container.

2. The microwave heating unit according to claim 1, wherein:
an electromagnetic field distribution of the microwave is in a single mode;
a part of a horizontal upper face of the wave guide is opened to be connected to the cylinder; and
a height of the wave guide is lower than a height of the container to be stored in the cylinder.

3. The microwave heating unit according to claim 1, further comprising a position changing means for changing a position of the wave guide in the height direction in the container stored in the cylinder.

4. The microwave heating unit according to claim 1, wherein the container in a bottle shape is stored in the cylinder with a spout faced toward a horizontal lower face side of the wave guide.

5. The microwave heating unit according to claim 1, further comprising a temperature measuring means for measuring temperatures of an upper face, bottom face and/or side face of the container stored in the cylinder.

6. The microwave heating unit according to claim 2, further comprising a position changing means for changing a position of the wave guide in the height direction in the container stored in the cylinder.

7. The microwave heating unit according to claim 2, further comprising a temperature measuring means for measuring temperatures of an upper face, bottom face and/or side face of the container stored in the cylinder.

8. The microwave heating unit according to claim 3, further comprising a temperature measuring means for measuring temperatures of an upper face, bottom face and/or side face of the container stored in the cylinder.

9. The microwave heating unit according to claim 3, wherein the position changing means has a table on which the container stored in the cylinder is loaded and can be moved in the height direction of the wave guide.

10. The microwave heating unit according to claim 5, wherein the temperature measuring means is an infrared radiation thermometer.

11. The microwave heating unit according to claim 5, wherein the temperature measuring means is a thermocouple thermometer.

12. The microwave heating unit according to claim 6, wherein the position changing means has a table on which the container stored in the cylinder is loaded and can be moved in the height direction of the wave guide.

13. The microwave heating unit according to claim 7, wherein the temperature measuring means is an infrared radiation thermometer.

14. The microwave heating unit according to claim 7, wherein the temperature measuring means is a thermocouple thermometer.

15. The microwave heating unit according to claim 8, wherein the temperature measuring means is an infrared radiation thermometer.

16. The microwave heating unit according to claim 8, wherein the temperature measuring means is a thermocouple thermometer.
